(19) United States
(12) Patent Application Publication
(10) Pub. No.: US 2008/0165325 A1
(43) Pub. Date: Jul. 10, 2008

(54) Subway information/advertisement project

(76) Inventor: Taras Vaylagya, Streamwood, IL (US)

Correspondence Address: Taras Vaylagya, 1549 McKool Ave., Streamwood, IL, 60107, US

(21) Appl. No.: 11/394,293

(22) Filed: Jan. 3, 2007

(51) Int. Cl. G03B 21/26

(52) U.S. Cl. 353/13

(57) ABSTRACT

For better comfort of passengers on the subway, a projector can be used. It can be mounted in the wall of the wagon so the image would appear outside on the well prepared wall of the subway tunnel. The wall of the tunnel needs to be prepared and painted white. For the legibility of the image, laser sensors of distance can be mounted by the projector. These can give a good focused image even on the walls which are in different distances from the wagon.

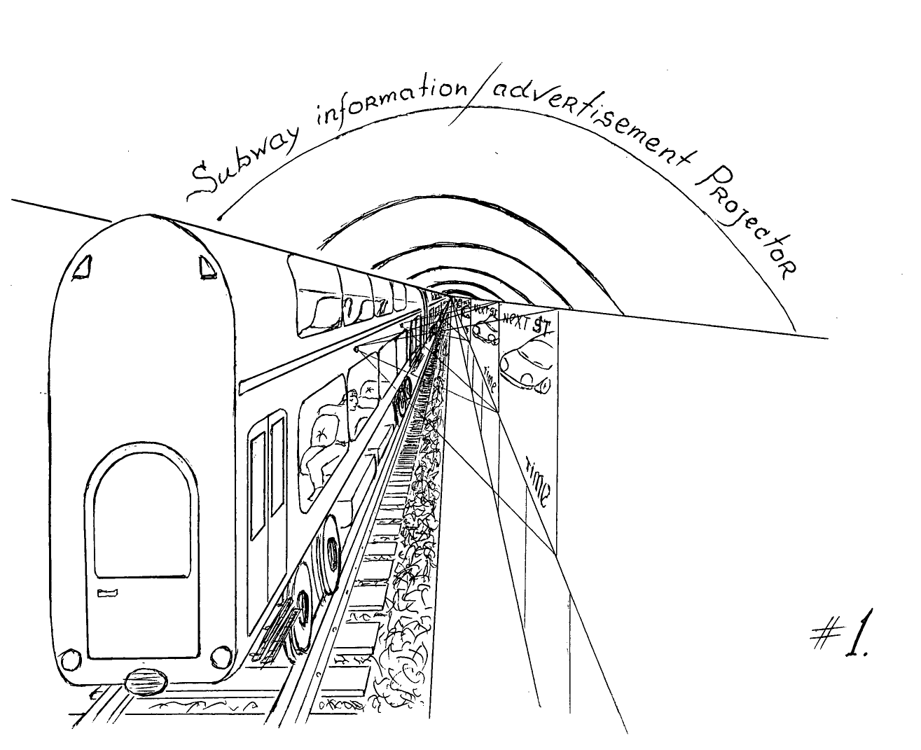

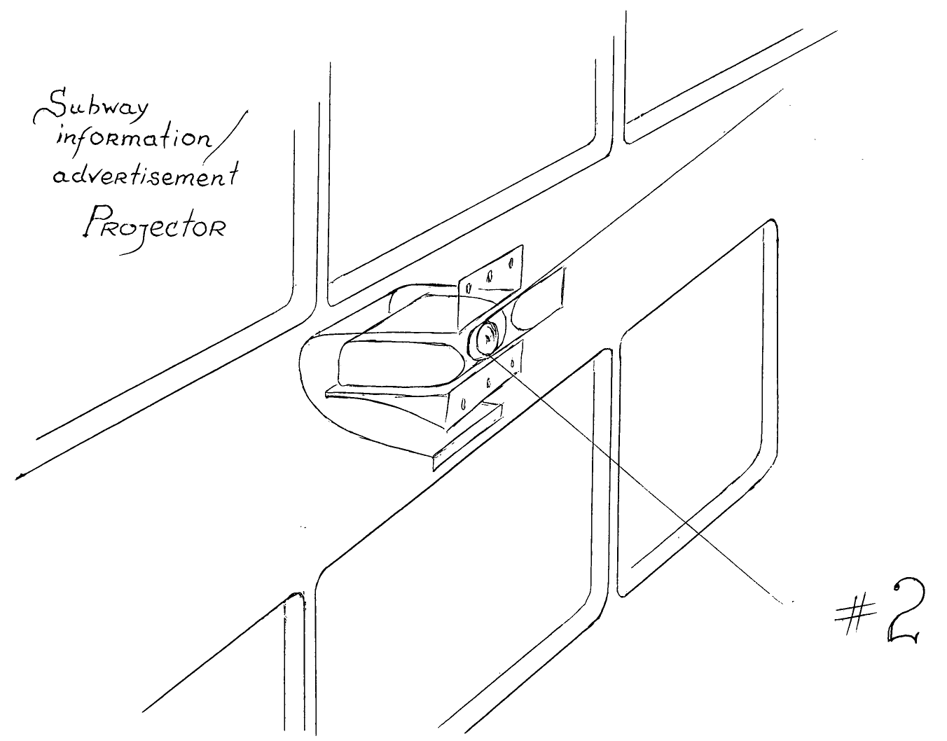

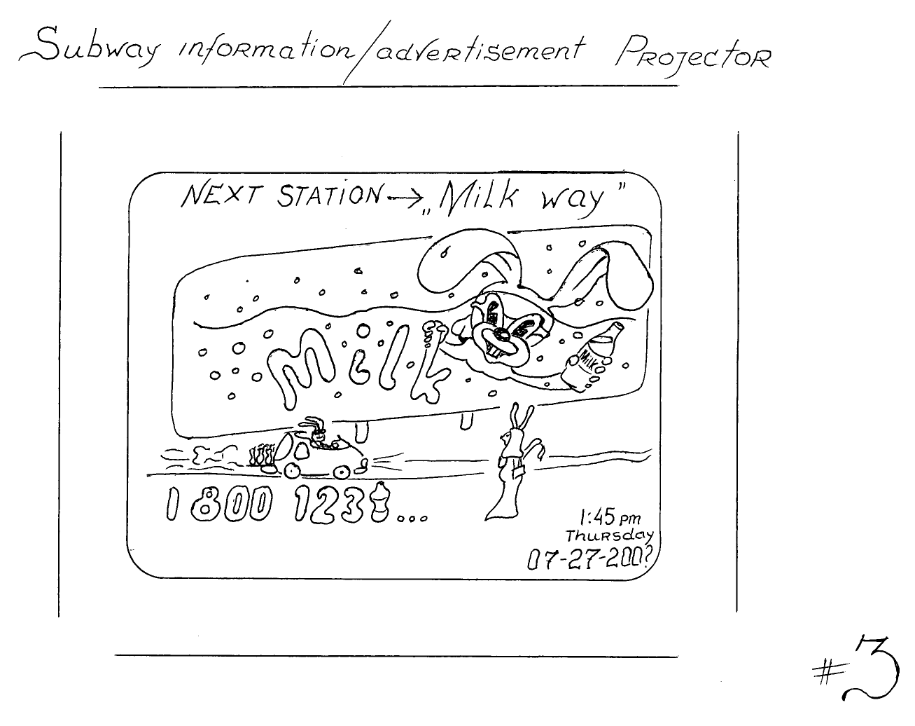

I wanted to share with you about one idea which came to me about fifteen years ago in the city Saint Petersburg Russia. The subway station there are made really fancy and the looks are just royal. But when you come in the subway train and you are moving through the tunnel, you see dark walls with fat electric cables. That is when I came up with an idea to replace all of that with some kind of commercial and also the time and place of the passenger's location. The tunnels in Chicago and in the whole world don't really differ from each other, that is why we have a chance to make a plastic surgery to the face of our subway. Starting with Chicago and then changing the minds of many people to make the subway traveling relaxing and enjoyable to passengers. I don't have the interest to make the screens in the back of the seats or on the walls, it is very easy to ruin and it just isn't comfortable. Instead, it is better to make it outside the subway train on the walls of the tunnel, so that it would be bigger, wider, and more comfortable to watch.

Lets put projectors into the wall of the wagon and transfer the image on the wall of the tunnel. This would probably bring more passengers and allow you to lower the price of tickets. Fitting this into life isn't that complicated. Our level of creativity and technology is pretty high. We've got VCR's DVD players, television, computers, internet, and even strait translation, all of this we can make even with dividing each wagon by categories of video translations. I believe that a country like America can make this happen to help bring a new step of life, business, and behavior.

1) (canceled)

2) It will give passengers multifarious information, it will also give the time and place of the subway's location for the passenger;

3) (canceled)

4) (canceled)

5) (canceled)

6) (canceled)

7) Also about the use of photo sensor, which will show a distance from the projector to the projection wall. This will make it possible to focus the contrast of the image and turn it off on an unable time for the projection of the image, for example: on the metro station or on it's way out of the tunnel;

8) We can also use different kinds of clear sensitive touch screens, sticking them on windows for the use of playing video games, or touching a motion image of an advertisement;

9) (canceled)
